(19) United States
(12) Patent Application Publication
(10) Pub. No.: US 2016/0352731 A1
(43) Pub. Date: Dec. 1, 2016

(54) NETWORK ACCESS CONTROL AT CONTROLLER

(71) Applicant: Hewlett Packard Enterprise Development LP, Houston, TX (US)

(72) Inventors: Duane Edward MENTZE, Roseville, CA (US); Shaun WAKUMOTO, Roseville, CA (US); Craig Joseph MILLS, Roseville, CA (US)

(21) Appl. No.: 15/117,241

(22) PCT Filed: May 13, 2014
(86) PCT No.: PCT/US2014/037892

§ 371 Date: Aug. 8, 2016

(51) Int. Cl. H04L 29/06

(52) U.S. Cl. CPC H04L 63/0876; H04L 63/0227

(57) ABSTRACT

An example system may include a controller to receive traffic of a host from a network device. The controller may include a network access control (NAC) unit and a network unit. The NAC unit may perform NAC authentication of the host. The network unit may indicate to the network device to allow traffic from the host, if the host is authenticated by the NAC unit.

### BACKGROUND

Network Access Control (NAC) may provide three services to a network: 1) authentication of its users; 2) dynamic policy enforcement and 3) visibility of active network users. Authentication of users may require all users to provide credentials before being allowed onto the network. This may allow guests or other user groups to receive custom access based on policies, including limited or even no network access. With dynamic policy enforcement, once authenticated, centralized network authentication servers may assign a policy for that user based criteria such as identity, group, location, and/or login time. This dynamic policy may move with the user as they login at different points in the network or at different times.

Visibility of active network users provides knowledge of who's on the network and what they're doing, which is an aspect to network administration. Accounting may provide a mapping between client device MAC address, login username, IP address, location, network activity statistics, and duration. Network accounting may also provide a historical view of user sessions for auditing purposes. For instance, when users authenticate with the network for access, the users may also provide an audit record that can be used for troubleshooting, monitoring, billing, forensics, etc.

### BRIEF DESCRIPTION OF THE DRAWINGS

The following detailed description references the drawings, wherein:

FIG. 1 is an example block diagram of a system including a controller to perform network access control (NAC);

FIG. 2 is another example block diagram of a system including a network device interfacing with a controller to perform NAC;

FIG. 3 is an example block diagram of a computing device including instructions for performing NAC; and

FIG. 4 is an example flowchart of a method for performing NAC.

### DETAILED DESCRIPTION

Specific details are given in the following description to provide a thorough understanding of embodiments. However, it will be understood that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

NAC deployments may require many moving pieces such as client software, switch firmware, authentication, authorization, and accounting (AAA) servers such as Remote Authentication Dial In User Service (RADIUS) servers, backend user databases and policy servers, all of which require special configurations. For example, some switches may require configuration parameters for the RADIUS client, NAC authenticator mode, switch port mode, etc. In addition, the communication protocol traffic may be traveling across a network that may be unreliable. Since this is seen as a client-login security mechanism, a failure case is almost always configured to fail closed, which means that the authenticating clients shall be left off the network. This may result in customer support calls and the network administrator may often be more concerned with network uptime rather than security. Therefore, NAC deployments are often abandoned.

Another major challenge with current NAC solutions is that deploying new/enhanced authentication mechanisms (e.g. 802.1X, MAC authentication, web portal, etc) on network devices can be challenging. For example, while porting software for an 802.1X authenticator on switch class A to switch class B may be difficult if using different hardware ASICs, CPU processor, device operating system, or architecture (single CPU, multiple CPU (chassis)), it may be even more difficult to port to a completely different class of device. Examples include porting to an access point, high-end router, low-end switch, firewall, etc.

NAC usually involves three components: 1) clients; 2) edge switches & access points (Aps); and 3) an AAA server. The client is required to provide some method of presenting login credentials to the network edge device. This can be in the form of an 802.1X supplicant (client software) or through a web portal. The network edge infrastructure is required to provide the services which takes the client credentials and sends them to the AAA server. The edge device also provides the enforcement of user policy and session tracking. The AAA server provides the authentication, authorization, and accounting services to the network. Examples of the AAA server include the FreeRADIUS and Microsoft NPS/IAS servers.

Thus, while NAC provides many benefits to the network, network administrator, and security officer, NAC can also result in many problems due to various reasons. Some example NAC problems may include the following: clients not having an 802.1X supplicant configured properly; misconfiguration of the edge switch/AP; lack of resources on the switch/AP resulting in clients not being allowed on the network (fail closed policy); misconfigured RADIUS server; RADIUS server not available (unreachable via the network); adding edge devices can be complex and/or require manual steps; traditional NAC may require device SW changes for extensibility; and the like.

Overall, there may be many moving pieces in the NAC solution (clients, switches, RADIUS servers, and the infrastructure that connects all of them). This solution may sometimes be difficult to troubleshoot even for an experienced network administrator. NAC hasn't been adopted and accepted by many customers. The low adoption rate may be due to many reasons including too many components, complex configurations, maintenance of a wide-scale deployment, etc.

Software Defined Network (SDN) may be applied to a NAC solution and eliminate or reduce many of these complexities and reduce administrative maintenance. Examples may move NAC components out of the network infrastructure and into a SDN-based solution. An example system may include a software-defined networking (SDN) controller to receive host traffic from a network device. The SDN controller may include a network access control (NAC) unit and a network unit. The NAC unit may perform NAC authentication of the host. The network unit may authorize the network device to allow traffic from the host, if the host is authenticated by the NAC unit.

Examples may provide many benefits from consolidating the NAC solution within the SDN controller. For instance, example controllers may provide a self-contained, single point of configuration, management, and policies. Further, example controllers may provide external lookups against a Microsoft Active Directory database for client authentication, or act as a RADIUS proxy, if the customer has a centralized RADIUS solution. Thus, examples may reduce or eliminate the RADIUS protocol traffic that previously traversed the network, such as between the switch and the RADIUS server. Moreover, examples may reduce or remove the AAA server, since a client database may be included in the controller.

Extensions to NAC may be carried out on the controller and not require device software changes. This may eliminate or reduce device configuration and authentication mechanism development on network devices. Thus, network devices may not have to be upgraded (hardware or software) to take advantage of newer authentication mechanisms/protocols.

An authentication mechanism chosen for a given client may be determined based on traffic from the client, not from the static configuration of the network port. All the while, the example controller may still inherit platform advantages such as scaling/clustering, failover and an accelerated development environment. Switch firmware may also be focused on multi-purpose functionality, as opposed to single feature firmware, due to the example controller.

Referring now to the drawings, FIG. 1 is an example block diagram of a system 100 including a controller 110 to perform network access control (NAC). The system 100 may be, for example, any type of network, such as a personal area network (PAN), a local area network (LAN), a home network, a storage area network (SAN), a campus network, a backbone network, a Metropolitan area network (MAN), a wide area network (WAN), an enterprise private network, a virtual private network (VPN), an Internetwork, and the like. The controller 110 may be a separate element or included in a switch, hub, router, gateway, storage device, computer, enclosure, server, access point (AP) and/or any type of device capable of managing network elements and/or connecting to a network.

The controller 110 may be a software-defined networking (SDN) controller to receive traffic of a host (not shown) from a network device (not shown). The SDN controller 110 may include NAC unit 120 and a network unit 130. The controller 110, including the NAC and network units 120 and 130, may include, for example, a hardware device including electronic circuitry for implementing the functionality described below, such as control logic and/or memory. In addition or as an alternative, the controller 110, including the NAC and network units 120 and 130, may be implemented as a series of instructions encoded on a machine-readable storage medium and executable by a processor.

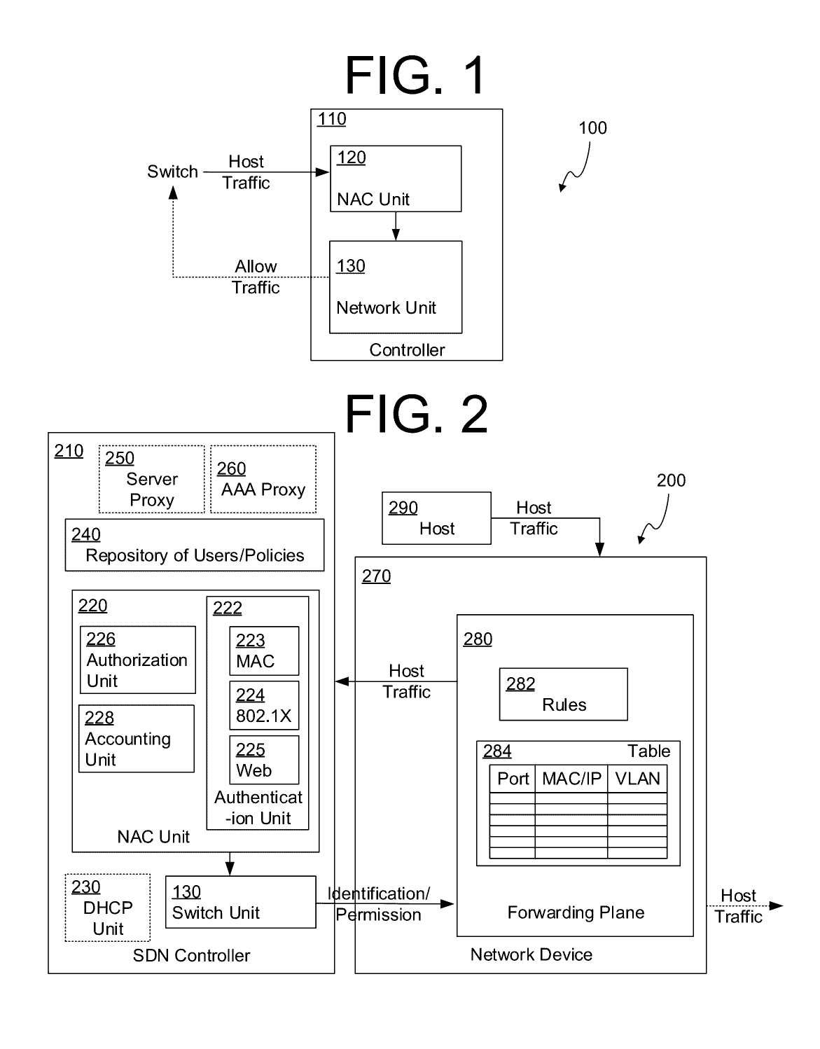

The NAC unit 120 may perform NAC authentication of the host. The network unit 130 may authorize the network device to allow traffic from the host, if the host is authenticated by the NAC unit. The NAC and network units 120 and 130 are described in further detail with respect to FIG. 2 below.

FIG. 2 is another example block diagram of a system 200 including a network device 270 interfacing with a controller 210 to perform NAC. As explained above, the system 200 may be any type of network. The controller 210 may be a separate element or included in a switch, hub, router, gateway, storage device, computer, enclosure, server, and/or any type of device capable of managing network elements and/or connecting to a network.

The controller 210 of FIG. 2 may at least respectively include the functionality and/or hardware of the controller 110 of FIG. 1. For example, the controller 210 includes the network unit 130 of FIG. 1 and a NAC unit 220. The controller 210 is further shown to include a repository 240 of users and/or policies. The controller 210 may optionally also include a server proxy 250, an AAA proxy 260 and a DHCP unit 230. The network device 270 may be a hub, switch, router, access point and/or any type of device to connect and/or link network elements together on a network. Further, the network device 270 may receive and forward data via physical ports that interface with links. The links may be any type of electrical connection between the network devices 270 used for transmitting the data, such as cables. While the system 200 only shows a single network device 270, examples may include a plurality of network devices.

The controller 210, network device 270, server proxy 250, AAA proxy 260 and DHCP unit 230 may include, for example, a hardware device including electronic circuitry for implementing the functionality described below, such as control logic and/or memory. In addition or as an alternative, the controller 210, network device 270, server proxy 250, AAA proxy 260 and DHCP unit 230 may be implemented as a series of instructions encoded on a machine-readable storage medium and executable by a processor. The host 290 may refer to any type of device that seeks to connect to the network device 270, such as a main processor of a computer, a terminal, a client, a computer connected to a network, and the like. While FIG. 2 shows a single host 290, examples may include a plurality of hosts 290 connected to a single host 290.

In the embodiment of FIG. 2, the network device 270 is shown to include a forwarding plane 280. The forwarding plane 280 is shown to further include rules 282. A control plane (not shown) may also be a part of a network device architecture related to drawing a network map and/or a routing table that defines what to do with incoming packets of traffic. The forwarding plane 280 may be a part of the network device architecture related to deciding what to do with the incoming packets arriving on an inbound interface, such as a look-up table 284 indicating the source address, destination address and/or outgoing interface of the incoming packet.

The SDN controller 210 and the network device 270 may communicate via a communication protocol that gives the SDN controller 210 access to the forwarding plane 280 of the network device 270 over a network, such as the OpenFlow protocol. The network device 270 is able to direct the specific traffic, such as that of different hosts, along different paths, based on a Software Defined Networking (SDN) architecture that separates the control plane from the forwarding plane 280 of the network device 270, such as the OpenFlow protocol.

For example, via OpenFlow, the controller 210 may access the forwarding plane 280 to setup one or more rules 282 for directing specific traffic. The rules 282 may be defined as any type of instruction delivered by the controller 210. The network device 270 may have the ability to forward all new host traffic to controller 210 (including 802.1X traffic), support OpenFlow rules for client policy enforcement and/or collect host statistics and behavior (e.g. type of traffic).

The OpenFlow may be a communications protocol that gives access to the forwarding plane 280 of the network device 270 over the network. Further, the OpenFlow protocol may allow the path of specific traffic through the network devices 270 to be dynamically determined by software or firmware running at a centralized location, such as the controller 210. The OpenFlow protocol provides a flexible classification mechanism for identifying traffic, such as by commanding devices to forward traffic based on rules. In FIG. 2 the controller 210 is shown to be separate from the network device 270. However, embodiments may include the controller 210 being included in the network devices 270 and/or being a higher layer device separate from the network devices 270.

The network device 270 may be programmed with a rule to redirect any unrecognized traffic to the SDN controller 210, such as that of a new host 290. For example, the network device 270 may learn at least one of a Media Access Control (MAC), Internet Protocol (IP) address of the host 290 transmitting the traffic to the network device 270. Further, the network device 270 may redirect the traffic of the host 290 to the SDN controller 210, if the at least one of MAC and IP address of the host 290 is not included in a table 284 of the network device 270.

The network device 270 does not directly perform NAC authentication of the host 290. As noted above, the NAC unit 220 of the SDN controller 210 may perform NAC authentication of the host 290. NAC authentication may refer to the process where the host's 290 identity is authenticated, such as by providing evidence that it holds a specific digital identity like an identifier and the corresponding credentials. Examples of types of credentials are passwords, one-time tokens, digital certificates, digital signatures, phone numbers (calling/called), and the like.

The NAC unit may include an authentication unit 222, an authorization unit 226 and an accounting unit 228. The authentication unit 222 may choose a type of the NAC authentication for the host 290 based on a type of the traffic from the host 290.

The authentication unit 222 may obtain user credentials and/or status information. Example types of NAC authentication may include Media Access Control (MAC) authentication 222, 802.1X authentication 224 and/or web authentication 226. MAC authentication 222 may relate to verifying a MAC address, which is a unique identifier assigned to network interfaces for communications on a physical network segment. MAC addresses are used as a network address for many IEEE 802 network technologies, including Ethernet. MAC addresses are often assigned by the manufacturer of a network interface controller (NIC) and are stored in its hardware, such as the card's read-only memory or some other firmware mechanism.

802.1X authentication 224 may relate to an IEEE Standard for Port-based Network Access Control (PNAC) and provide an authentication mechanism to devices wishing to attach to a LAN or WLAN. Web authentication 225 may relate to the host 290 transmitting security information via a web browser, such as a user name, password, key and the like. In one example, the network device 270 may capture and transmit authentication protocol packets to the authentication unit 222. The authentication unit 222 may determine the type of the authentication based on the type of authentication control packets.

The authentication unit 222 may also use other criteria for authentication, such as device/host status in order for an administrator to decide whether to allow a valid user with a potentially compromised device onto a network. The device/host status may include account attributes such as OS version/patches, antivirus patch level, firewall running status, and the like.

The authentication unit 222 may take any of the above-mentioned credentials obtained from the host traffic and verify it. For example, for MAC, 802.1X, web or any other type of NAC authentication, the authentication unit 222 may use the obtained credentials as a lookup via the local repository 240, the AAA proxy 260, the server proxy 250, and the like. If the host 290 is authenticated by the authentication unit 222, the authorization unit 226 may further perform NAC authorization.

NAC authorization may determine whether a particular host or user is authorized to perform a given activity, such as when logging on to an application or service. Authorization may be determined based on a range of restrictions, such as time-of-day restrictions, physical location restrictions, restrictions against multiple access by the same entity or user, application restrictions, user access restrictions, device-type restrictions, and the like. For example, the authorization unit 226 may grant read access to a specific file for a specific authenticated user. Examples types of service may include IP address filtering, address assignment, route assignment, quality of Service/differential services, bandwidth control/traffic management, compulsory tunneling to a specific endpoint, encryption and the like. In another example, the authorization unit 226 may only allow traffic of certain types of devices, such as mobile devices or devices from a specific location.

The authorization unit 226 may store policy for the types of authorization, such as at the local repository 240, and/or obtain the policy, such as via the AAA proxy 260 or the server proxy 250. Further, the authorization unit 226 may include local authorization policy, such as for a single network device 270 and/or a global authorization policy, such as for a plurality of network devices 270 of a network. Thus, the controller 210 may dynamically distribute an authorization policy across a plurality of network devices 270 to carry out a NAC solution.

The accounting unit 228 may carry out accounting, which refers to the tracking of network resource consumption by users/hosts for the purpose of capacity and trend analysis, cost allocation, billing, and the like. In addition, accounting my refer to recording events such as authentication and authorization failures, and include auditing functionality, which permits verifying the correctness of procedures carried out based on accounting data. The accounting unit 228 may carry out real-time and/or batch accounting. Real-time accounting may refer to accounting information that is delivered concurrently with the consumption of the resources. Batch accounting may refer to accounting information that is saved until it is delivered at a later time. Example information that is gathered in accounting may include the identity of the user, host or other entity, the nature of the service delivered, when the service began, and when it ended, if there is a status to report, username, IP address (via DHCP snooping), location (network device IP address, network device port), login time, duration, VLAN, network statistics, application statistics, operating system and the like.

The NAC unit 226 may indicate to the network unit 130 to authorize the network device 270 to allow traffic from the host 290, if the host 290 is authorized by the authorization unit 226. In turn, the network unit 130 may transmit identification information and/or an permission rule to the network device 270, if the host 290 is authenticated and authorized by the NAC unit 220. The identification information may relate to identifying the host 290 of the traffic and may be obtained from the authentication and/or accounting units 222 and 228. The permission rule may relate to controlling the traffic of the host 290 and may be obtained from authorizing and/or accounting units 226 and 228.

The identification information may relate to an ingress port number, a source MAC address, an IP address and/or a virtual local area network (VLAN) of the host 290. The permission rule may include which network the host 290 can access, how much data the host 290 can send/receive and how the traffic of the host 290 is prioritized compared to other traffic. The permission rule may be pushed by the controller 210 to the network device 270 via OpenFlow.

The network device 270 may redirect the traffic of the host 290 if the identification information of the traffic does not match identification information in the table 284 of the network device 270. The network device 270 may add the identification information to the table 284, if the network unit 130 authorizes the network device to allow the traffic from the host. For, example, the network device 270 may add the MAC and/or IP address of the host 290 to the table 284, if the network unit 130 sends the identification information identifying the host 290 to the network device 270 and/or the permission rule to the network device 270 that allows the traffic of the host 290. The network device 270 may allow the traffic of the host 290, if the MAC and/or IP address of the host 290 is already included in the table 284 of the network device 270.

The SDN controller 210 may also provide the local repository 240 of users and policies, a proxy to an authentication, authorization, and accounting (AAA) server 260 to authenticate the host (such as a Remote Authentication Dial In User Service (RADIUS) server) and/or a proxy to another type of server 250, such as to obtain policies or client credentials. Only the SDN controller 210 may have to be updated for software and/or policy updates related to NAC authentication.

Example protocols the controller 210 may use to further communicate with the network device 270 and other network elements may include the Link Layer Discovery Protocol (LLDP), Simple Network Management Protocol (SNMP), Dynamic Host Configuration Protocol (DHCP), Simple Service Discovery Protocol (SSDP), Universal Plug and Play (UPnP) and the like.

The DHCP unit 230 may snoop and inspect DHCP packets sent to the network device 270 for processing. This allows the network device 270 to learn all MAC/IP/port bindings before reforwarding the DHCP packets back on the network. The DHCP unit 230 may include the IP address in a local repository of active client data, such as the repository 240 of the controller 210. In this case, the network device 270 may send all DHCP packets to the controller 210.

The SDN controller 210 may determine the operating system (OS) of the device using the DHCP options and/or http browser agent string. For example, the controller 210 may periodically sample host HTTP traffic at a given rate, such as via sFlow. Examples may also use other mechanisms to determine a device manufacturer, such as device or OS fingerprinting. The SDN controller 210 may provide an Application Program Interface (API) (not shown), which may be accessed by other SDN applications or external entities wishing to obtain the valuable client visibility information.

As noted above, one of the deficiencies with mobility is its lack of advanced policy enforcement. Access Control Lists (ACLs) and rate limits are enforced at either the network device infrastructure or controller as the APs themselves may not have the processing power to do so. The result is either a static policy enforcement on the edge network device or increased load on the controller. As examples move the NAC functionality to the controller 210, dynamic policy enforcement rules may come from the controller 210 and be programmed using OpenFlow.

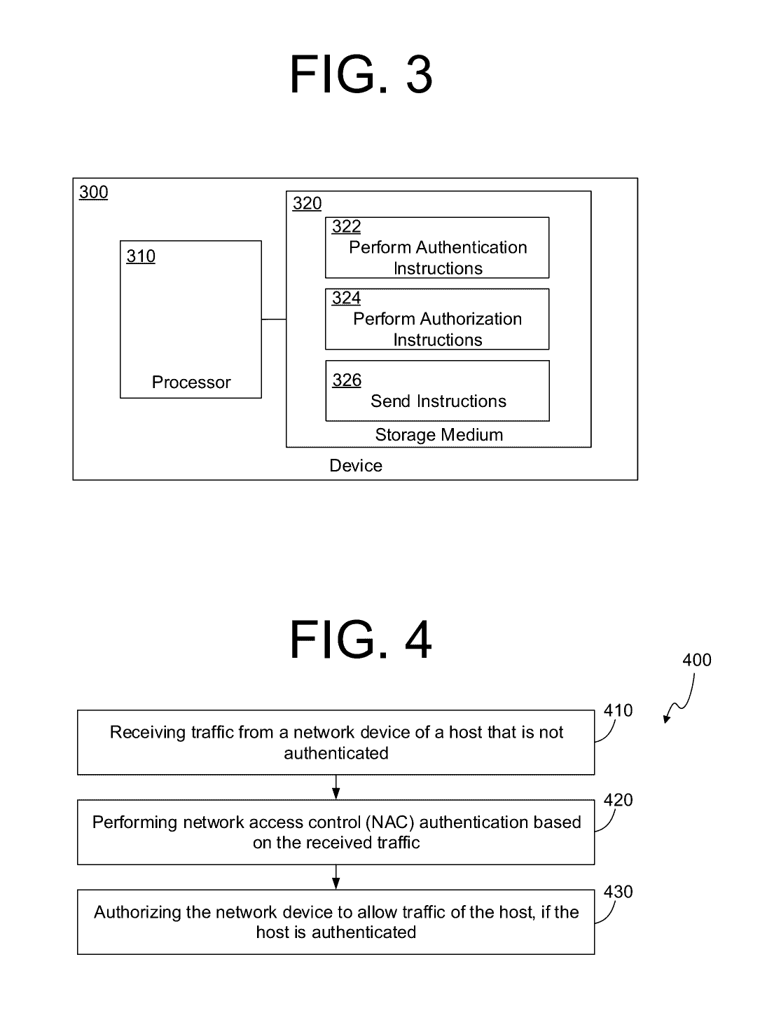

FIG. 3 is an example block diagram of a computing device 300 including instructions for performing NAC. In the embodiment of FIG. 3, the computing device 300 includes a processor 310 and a machine-readable storage medium 320. The machine-readable storage medium 320 further includes instructions 322, 324 and 326 for performing NAC.

The computing device 300 may be or part of, for example, a controller, server, a network switch, a hub, a router, a gateway, an access point, a network element, or any other type of device capable of executing the instructions 322, 324 and 326. In certain examples, the computing device 300 may include or be connected to additional components such as memories, sensors, displays, etc.

The processor 310 may be, at least one central processing unit (CPU), at least one semiconductor-based microprocessor, at least one graphics processing unit (GPU), other hardware devices suitable for retrieval and execution of instructions stored in the machine-readable storage medium 320, or combinations thereof. The processor 310 may fetch, decode, and execute instructions 322, 324 and 326 for performing NAC. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for performing NAC.

Moreover, the instructions 322, 324 and 326 when executed by a processor (e.g., via one processing element or multiple processing elements of the processor) can cause the processor to perform processes, such as, the process of FIG. 4. For example, the perform authentication instructions 322 may be executed by the processor 310 to perform network access control (NAC) authentication of a host (not shown) based on traffic of the host. The perform authorization instructions 324 may be executed by the processor 310 to perform NAC authorization of the host, if the host is authenticated. The send instructions 326 may be executed by the processor 310 to send a rule to a network device (not shown) to permit the traffic of the host, if the host is authorized.

The network device may redirect the traffic of the host to the controller, if the host is not authorized. Although not shown, the machine-readable storage medium 320 may further include instructions, that when executed by the processor 310, send a rule to the network device to redirect the traffic from the network device to the controller, if the traffic is not authorized.

FIG. 4 is an example flowchart of a method 400 for performing NAC. Although execution of the method 400 is described below with reference to the controller 210, other suitable components for execution of the method 400 can be utilized, such as the controller 110. Additionally, the components for executing the method 400 may be spread among multiple system and/or devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the controller 210 receives traffic from a network device 270 of a host 290 that is not authenticated. Then, at block 420, the controller 210 performs NAC authentication based on the received traffic. For example, the NAC authentication may include 802.1X, web and/or MAC authentication on the traffic. However, examples are not limited thereto and may carry out any form of authentication. Next, at block 430, the controller 210 authorizes the network device 270 to allow traffic of the host 290, if the host 290 is successfully authenticated.

The network device 270 may redirect traffic to the controller 210, if the host 290 is not authorized. For example, the network device 270 may redirect the traffic to the controller 210, if at least one of a Media Access Control (MAC), Internet Protocol (IP) address of the host 290 does not match an entry of a table 284 of the network device 270. Further, the network device 270 and/or controller 210 may collect data from the host, if the host is not authorized, such as identification information. In one example, the network device 270 may further redirect the traffic to a guest network, if the host is not authorized, such as an unsecured network.

We claim:

1. A system, comprising:
a software-defined networking (SDN) controller to receive traffic of a host from a network device, wherein the SDN controller includes,
a network access control (NAC) unit to perform NAC authentication of the host, and
a network unit to indicate to the network device to allow traffic from the host, if the host is authenticated by the NAC unit.

2. The system of claim 1, wherein,
the SDN controller includes,
an authentication unit to authenticate an identity of the host, and
an authorization unit to authorize the host to perform an activity, if the host is authenticated, and
the network unit is to indicate to the network device to allow traffic from the host, if the host is authorized by the authorization unit.

3. The system of claim 2, wherein,
the network unit is to transmit at least one of identification information and a permission rule to the network device, if the host is authorized by the authorization unit,
the identification information relates to identifying the host of the traffic, and
the permission rule relates to controlling the traffic of the host.

4. The system of claim 3, wherein,
the identification information relates to at least one of an ingress port, a user name, a Media Access Control (MAC) address, an Internet Protocol (IP) address, a virtual local area network (VLAN), a password, a token, a digital certificate, a digital signature and an account attribute of the host, and
the permission rule relates to at least one of a time-of-day restriction, a physical location restriction, a restrictions against multiple access by the same user, an application restriction, a user access restriction, a network access restriction, a data limit restriction, a device restriction, and a priority of the traffic of the host.

5. The system of claim 3, wherein,
the network device is to redirect the traffic of the host if the identification information of the traffic does not match authentication information in a table of the network device, and
the network device is to add the authentication information to the table, if the network unit authorizes the network device to allow the traffic from the host.

6. The system of claim 2, wherein,
the NAC unit further includes an accounting unit to track network resource consumption by the host, and
the authentication unit is to choose a type of the authentication for the host based on a type of the traffic from the host.

7. The system of claim 2, wherein,
the authentication unit is to obtain at least one of user credentials and a status information, when the authentication unit performs NAC authentication of the host,
the authorization unit is to obtain at least one of a rule and a policy, when the authorization unit performs NAC authorization of the host.

8. The system of claim 2, wherein
the network device is to capture and transmit authentication protocol packets to the NAC unit,
the NAC unit is to determine the type of the authentication based on the type of authentication control packets, and
the controller further includes a Dynamic Host Configuration Protocol (DHCP) unit to at least one of snoop and inspect DHCP packets sent to the network device for processing.

9. The system of claim 1, wherein,
the SDN controller is provide at least one of a local repository of users and policies, access to an authentication, authorization, and accounting (AAA) server and a policy server, and
the SDN controller is to obtain client credentials.

10. The system of claim 1, wherein,
the SDN controller and network device are to communicate via Openflow,
the SDN controller is to push rules to the network device, and
only the SDN controller is updated for at least one of software and policy updates related to NAC authentication.

11. A method, comprising:
receiving, at a controller, traffic from a network device of a host that is not authenticated;
performing, at the controller, network access control (NAC) authentication based on the received traffic; and
authorizing, at the controller, the network device to allow traffic of the host, if the host is authenticated, wherein
the network device is to redirect traffic to the controller, if the host is not authorized.

12. The method of claim 11, wherein,
at least one of the network device and the controller are to collect data from the host, if the host is not authorized, and
the network device is to further redirect the traffic to a guest network, if the host is not authorized.

13. The method of claim 11, wherein,
the host is not authorized if at least one of a Media Access Control (MAC) and Internet Protocol (IP) address of the host does not match an entry of a table of the network device, and
the NAC authentication includes at least one of 802.1X, web and MAC authentication on the traffic at the controller.

14. A non-transitory computer-readable storage medium storing instructions that, if executed by a processor of a controller, cause the processor to:
perform network access control (NAC) authentication of a host based on traffic of the host;
perform NAC authorization of the host, if the host is authenticated; and
send a rule to a network device to permit the traffic of the host, if the host is authorized, wherein
the network device is to redirect the traffic of the host to the controller, if the host is not authorized.

15. The non-transitory computer-readable storage medium of claim 14, further storing instructions that, if executed by a processor of the controller, cause the processor to:
send a rule to the network device to redirect the traffic from the network device to the controller, if the traffic is not authorized.
